(19) United States
(12) Patent Application Publication
(10) Pub. No.: US 2014/0058003 A1
(43) Pub. Date: Feb. 27, 2014

(54) POLYMERIC FOAMS INCLUDING FLUORINATED OXIRANES, METHODS OF PREPARATION, AND USE OF SAME

(71) Applicants: John G. Owens, Woodbury, MN (US); Zhongxing Zhang, Woodbury, MN (US); Rudolf J. Dams, Antwerp (BE)

(72) Inventors: John G. Owens, Woodbury, MN (US); Zhongxing Zhang, Woodbury, MN (US); Rudolf J. Dams, Antwerp (BE)

(73) Assignee: 3M INNOVATIVE PROPERTIES COMPANY, St. Paul, MN (US)

(21) Appl. No.: 14/112,595

(22) PCT Filed: Apr. 10, 2012
(86) PCT No.: PCT/US2012/032827

§ 371 Date: Oct. 18, 2013

Related U.S. Application Data
(60) Provisional application No. 61/487,893, filed on May 19, 2011.

(51) Int. Cl. C08J 9/00

(52) U.S. Cl. CPC C08J 9/0023
USPC 521/88; 516/12; 521/174

(57) ABSTRACT

Foamable compositions are provided that include at least one blowing agent, at least one foamable polymer or a precursor composition thereof, and a nucleating agent. The nucleating agent includes a fluorinated oxirane which, in some embodiments, can have up to a maximum of three hydrogen atoms. The fluorinated oxiranes can have a total of from about 2 to about 12 carbon atoms. Also provided is a process for preparing a polymeric foam and a composition that includes a blowing agent and a nucleating agent comprising a fluorinated oxirane.

### FIELD

The present disclosure relates to the use of fluorinated oxiranes as nucleating agents in the production of polymeric foams and in particular in the production of polyurethane foams and phenolic foams.

### BACKGROUND

According to “Cellular Materials”, Encyclopedia of Polymer Science and Engineering, vol. 3, pages 1-59, (2d ed. John Wiley & Sons, 1985), foamed plastic is defined as a plastic in which the apparent density decreases substantially with the presence of numerous cells disposed through its mass. The gas phase in a foamed plastic is generally distributed in cells which are preferably very fine to provide good thermal insulation

Blowing agents produce gas used to generate cells in foamable polymeric materials, for example, to make foamed insulation. Physical blowing agents form cells by a phase change, for example, a liquid may be volatilized or a gas dissolved in a polymer under high pressure. Low boiling (e.g., typically less than 80° C., more typically less than about 50° C.) liquids, particularly chlorofluorocarbons (CFCs) and hydrochlorofluorocarbons (HCFCs), have been used throughout the world on a large scale to produce foamed plastics. However, CFCs and HCFCs are linked to the destruction of the earth's protective ozone layer.

Commercially important liquid blowing agents include aliphatic and cycloaliphatic hydrocarbons and their chloro- and fluoro-derivatives. For example, isomers of pentane, hexane, and heptane are used mainly in the production of very low density polystyrene foam. These liquids tend to be inexpensive and low in toxicity but they are highly flammable. Production of cellular plastic products, such as cellular polyurethane elastomers and flexible, semi-rigid or rigid polyurethane foams in the presence of catalysts, blowing agents, processing aids or additives is described in numerous patents and publications in the literature.

Essentially two types of blowing agents are used to produce cellular polyurethanes:

(1) low boiling inert liquids that evaporate under the influence of the exothermic polymerization process, for example, alkanes, such as butane, n-pentane, isopentane or cyclopentane, halogenated hydrocarbons or halogenated fluorocarbons, such as methylene chloride, dichloromonofluoromethane, and trichlorofluoromethane or mixtures thereof; and (2) chemical compounds that form gaseous blowing agents by means of a chemical reaction or thermal decomposition, such as isocyanate groups reacted with water to produce carbon dioxide.

After the phase out of chlorofluorocarbon (“CFC”) production, many polymeric foams are produced using HCFC-141b (CCl₂FCH₃) as the blowing agent. With the impending phase out of this blowing agent many producers are looking to use hydrocarbons such as cyclopentane as blowing agents. While foam manufacturers are discovering that they can safely handle the relatively high flammability of these blowing agents, the resultant foams exhibit relatively higher thermal conductivity, a significant drawback to these blowing agents. Foams produced with nonhalogenated blowing agents such as cyclopentane or CO₂ (produced in situ via the reaction of water with the isocyanate) typically exhibit thermal conductivities which are 10 to 15 percent higher than those produced with halogenated blowing agents such as HFC-245fa (CF₃CH₂CHF₂).

Whereas the blowing agent provides the essential volume to form the voids in the foamable resin that become the resultant cells in the finished foam, nucleating agents can provide the initiating sites at which the blowing agent forms the voids. By selection of nucleating agent, foams with fewer relatively larger voids and a greater number of relatively smaller voids can be produced.

It has been reported that low concentrations of perfluorinated compounds such as C₅F₁₂, C₆F₁₄, and C₅F₁₁NO can be used as a nucleating agent to cause generation of smaller cell sizes in foams. As a result, such foams can exhibit lower thermal conductivity. However, due to the long atmospheric lifetimes and high global warming potentials of perfluorinated compounds, their use as nucleating agents is not environmentally desirable. Unsaturated perfluorinated compounds such as HFP dimer [(CF₃)₂CFCF═CFCF₃)] have also shown promise as a nucleating agent and have offered better environmental properties as compared to perfluorinated compounds. However, unsaturated perfluorinated compounds have been found to react with some of the tertiary amine catalysts used in foam formulations. Consequently, their use is limited to foam formulations containing compatible catalysts or processes in which the nucleating agent can be introduced in to the formulation immediately prior to foaming.

Another alternative is to use partially fluorinated compounds that have been introduced as replacements for CFCs, HCFCs, and PFCs in other applications. Replacement materials such as 3M NOVEC Brand HFE-7100 and HFE-7200 (available from 3M Company, St. Paul, Minn.) have desirable environmental and toxicological properties but have failed to provide acceptable performance as nucleating agents in foams.

### SUMMARY

Thus, the need exists for nucleating agents that exhibit desirable environmental and toxicological properties and function as acceptable nucleating agents and yield higher performing polymeric foams. A foamable composition is provided for preparing polymeric foams, a process for preparing polymeric foam, a blowing agent composition for preparing polymeric foam, and foams made therewith. The provided foamable composition includes at least one blowing agent, at least one foamable polymer or a precursor composition thereof, and at least one nucleating agent as described herein. The provided process comprises a process for preparing polymeric foam comprising the step of vaporizing at least one liquid or gaseous blowing agent or generating at least one gaseous blowing agent in the presence of at least one foamable polymer or a precursor composition thereof and at least one nucleating agent as described herein. The provided blowing agent composition comprises at least one blowing agent and at least one nucleating agent as described herein.

In one aspect, a foamable composition is provided that includes at least one blowing agent, at least one foamable polymer or a precursor composition thereof, and a nucleating agent wherein said nucleating agent comprises a fluorinated oxirane. In some embodiments, the fluorinated oxirane can include up to a maximum of three hydrogen atoms. In other embodiments, the fluorinated oxirane can contain substantially no hydrogen atoms bonded to carbon atoms. The fluorinated oxirane can have a total of from 4 to about 12 carbon atoms and, in some embodiments can have the formula:

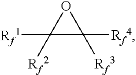

wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring. The nucleating agent and the blowing agent can be in a molar ratio of less than 1:9. The blowing agent can be selected from the group consisting of aliphatic hydrocarbons having from about 5 to about 7 carbon atoms, cycloaliphatic hydrocarbons having from about 5 to about 7 carbon atoms, hydrocarbon esters and water.

In another aspect, a process for preparing a polymeric foam is provided that includes the step of vaporizing at least one liquid or gaseous blowing agent or generating at least one gaseous blowing agent in the presence of at least one foamable polymer or a precursor composition thereof and a nucleating agent wherein said nucleating agent comprises a fluorinated oxirane. The fluorinated oxirane can have a composition as disclosed above.

In yet another aspect, a composition is provided that includes a blowing agent and a nucleating agent wherein the nucleating agent comprises a fluorinated oxirane.

In this disclosure:

“in-chain heteroatom” refers to an atom other than carbon (for example, oxygen and nitrogen) that is bonded to carbon atoms in a carbon chain so as to form a carbon-heteroatom-carbon chain;

“inert” refers to chemical compositions that are generally not chemically reactive under normal conditions of use;

“fluorinated” refers to hydrocarbon compounds that have one or more C—H bonds replaced by C—F bonds;

“oxirane” refers to a substituted hydrocarbon that contains at least one epoxy group; and

“perfluoro-” (for example, in reference to a group or moiety, such as in the case of “perfluoroalkylene” or “perfluoroalkylcarbonyl” or “perfluorinated”) means completely fluorinated such that, except as may be otherwise indicated, there are no carbon-bonded hydrogen atoms replaceable with fluorine.

In addition to providing useful performance as nucleating agents, the fluorinated oxiranes useful herein can offer additional important benefits in safety of use and in environmental compatibility (e.g., zero ozone depletion potential and low atmospheric lifetime as compared to perfluoroalkanes). The fluorinated oxiranes described herein are non-ozone depleting and as a result of their degradation in the lower atmosphere, have short atmospheric lifetimes, and would not be expected to contribute significantly to global warming. Further, polymeric foams produced in accordance with the invention have excellent thermal insulation properties.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a graph of the fluoride ion concentration as a function of time of two comparative examples and two exemplary foamable compositions.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Foamable compositions are provided that include at least one blowing agent, at least one foamable polymer or a precursor composition thereof, and a nucleating agent. The nucleating agent includes a fluorinated oxirane. A variety of blowing agents may be used in the provided formable compositions including liquid or gaseous blowing agents that are vaporized in order to foam the polymer or gaseous blowing agents that are generated in situ in order to foam the polymer.

Illustrative examples of blowing agents include chlorofluorocarbons (CFCs), hydrochlorofluorocarbons (HCFCs), hydrofluorocarbons (HFCs), hydrochlorocarbons (HCCs), iodofluorocarbons (IFCs), hydrocarbons, and hydrofluoroethers (HFEs). The blowing agent for use in the provided foamable compositions can have a boiling point of from about −45° C. to about 100° C. at atmospheric pressure. Typically, at atmospheric pressure the blowing agent has a boiling point of at least about 15° C., more typically between about 20° C. and about 80° C. The blowing agent can have a boiling point of between about 30° C. and about 65° C.

Illustrative examples of blowing agents that can be used in the invention include aliphatic and cycloaliphatic hydrocarbons having about 5 to about 7 carbon atoms, such as n-pentane and cyclopentane, esters such as methyl formate, CFCs such as CFCl₃ (CFC-11) and CCl₂FCClF₂ (CFC-113), HFCs such as CF₃CF₂CHFCHFCF₃, CF₃CH₂CF₂H, CF₃CH₂CF₂CH₃, CF₃CF₂H, CH₃CF₂H(HFC-152a), CF₃CH₂CH₂CF₃ and CHF₂CF₂CH₂F, HCFCs such as CH₃CCl₂F, CF₃CHCl₂, and CF₂HCl, HCCs such as 2-chloropropane, and IFCs such as CF₃I, and HFEs such as C₄F₉OCH₃. In certain formulations CO₂ generated from the reaction of water with foam precursor such as an isocyanate can be used as a blowing agent.

The provided foamable composition also includes at least one foamable polymer or a precursor composition thereof. Foamable polymers suitable for use in the provided foamable compositions include polyolefins, e.g., polystyrene, poly(vinyl chloride), and polyethylene. Foams can be prepared from styrene polymers using conventional extrusion methods. The blowing agent composition can be injected into a heat-plastified styrene polymer stream within an extruder and admixed therewith prior to extrusion to form foam. Representative examples of suitable styrene polymers include the solid homopolymers of styrene, α-methylstyrene, ring-alkylated styrenes, and ring-halogenated styrenes, as well as copolymers of these monomers with minor amounts of other readily copolymerizable olefinic monomers, e.g., methyl methacrylate, acrylonitrile, maleic anhydride, citraconic anhydride, itaconic anhydride, acrylic acid, N-vinylcarbazole, butadiene, and divinylbenzene. Suitable vinyl chloride polymers include vinyl chloride homopolymer and copolymers of vinyl chloride with other vinyl monomers. Ethylene homopolymers and copolymers of ethylene with, e.g., 2-butene, acrylic acid, propylene, or butadiene are also useful. Mixtures of different types of polymers can be employed.

Precursors of foamable polymers suitable for use in the provided foamable compositions include precursors of phenolic polymers, silicone polymers, and isocyanate-based polymers, e.g., polyurethane, polyisocyanurate, polyurea, polycarbodiimide, and polyimide. Typically, precursors of isocyanate-based polymers are utilized as the blowing for preparing polyurethane or polyisocyanurate foams.

Polyisocyanates suitable for use in the provided foamable compositions include aliphatic, alicyclic, arylaliphatic, aromatic, or heterocyclic polyisocyanates, or combinations thereof. Any polyisocyanate which is suitable for use in the production of polymeric foams can be utilized. Of particular importance are aromatic diisocyanates such as toluene and diphenylmethane diisocyanates in pure, modified, or crude form. MDI variants (diphenylmethane diisocyanate modified by the introduction of urethane, allophanate, urea, biuret, carbodiimide, uretonimine, or isocyanurate residues) and the mixtures of diphenylmethane diisocyanates and oligomers thereof known in the art as crude or polymeric MDI (polymethylene polyphenylene polyisocyanates) are especially useful.

Representative examples of suitable polyisocyanates include ethylene diisocyanate, 1,4-tetramethylene diisocyanate, 1,6-hexamethylene diisocyanate, trimethyl hexamethylene diisocyanate, 1,12-dodecane diisocyanate, cyclobutane-1,3-diisocyanate, cyclohexane-1,3- and -1,4-diisocyanate (and mixtures of these isomers), diisocyanato-3,3,5-trimethyl-5-isocyanatomethyl cyclohexane, 2,4- and 2,6-toluene diisocyanate (and mixtures of these isomers), diphenylmethane-2,4′- and/or -4,4′-diisocyanate, naphthalene-1,5-diisocyanate, the reaction products of four equivalents of the aforementioned isocyanate-containing compounds with compounds containing two isocyanate-reactive groups, triphenyl methane-4,4′,4″-triisocyanate, polymethylene polyphenylene polyisocyanates, m- and p-isocyanatophenyl sulfonyl isocyanates, perchlorinated aryl polyisocyanates, polyisocyanates containing carbodiimide groups, norbornane diisocyanates, polyisocyanates containing allophanate groups, polyisocyanates containing isocyanurate groups, polyisocyanates containing urethane groups, polyisocyanates containing acrylated urea groups, polyisocyanates containing biuret groups, polyisocyanates produced by telomerization reactions, polyisocyanates containing ester groups, reaction products of the above-mentioned diisocyanates with acetals, polyisocyanates containing polymeric fatty acid esters, and mixtures thereof. Distillation residues (obtained in the commercial production of isocyanates) having isocyanate groups can also be used alone or in solution in one or more of the above-mentioned polyisocyanates.

Reactive hydrogen-containing compounds suitable for use in the preferred foamable compositions of the invention are those having at least two isocyanate-reactive hydrogen atoms, preferably in the form of hydroxyl, primary or secondary amine, carboxylic acid, or thiol groups, or a combination thereof. Polyols, i.e., compounds having at least two hydroxyl groups per molecule, are especially preferred due to their desirable reactivity with polyisocyanates. Such polyols can be, e.g., polyesters, polyethers, polythioethers, polyacetals, polycarbonates, polymethacrylates, polyester amides, or hydroxyl-containing prepolymers of these compounds and a less than stoichiometric amount of polyisocyanate.

Representative examples of suitable reactive hydrogen-containing compounds have been described, e.g., by J. H. Saunders and K. C. Frisch in High Polymers, Volume XVI, “Polyurethanes,” Part I, pages 32-54 and 65-88, Interscience, New York (1962). Mixtures of such compounds are also useful, and, in some cases, it is particularly advantageous to combine low-melting and high-melting polyhydroxyl-containing compounds with one another, as described in DE 2,706,297 (Bayer AG). Useful polyols include ethylene glycol, 1,2- and 1,3-propylene glycol, 1,4- and 2,3-butylene glycol, 1,5-pentane diol, 1,6-hexane diol, 1,8-octane diol, neopentyl glycol, 1,4-bis(hydroxymethyl)cyclohexane, 2-methyl-1,3-propane diol, dibromobutene diol, glycerol, trimethylolpropane, 1,2,6-hexanetriol, trimethylolethane, pentaerythritol, quinitol, mannitol, sorbitol, diethylene glycol, triethylene glycol, tetraethylene glycol, higher polyethylene glycols, dipropylene glycol, higher polypropylene glycols, dibutylene glycol, higher polybutylene glycols, 4,4′-dihydroxydiphenyl propane, and dihydroxymethyl hydroquinone. Other suitable polyols include the condensation products of polybasic acids and polyols such as polyethylene adipate and polycaprolactone-based polyols, as well as the mixtures of hydroxy aldehydes and hydroxy ketones (“formose”) and the polyhydric alcohols obtained therefrom by reduction (“formitol”) that are formed in the autocondensation of formaldehyde hydrate in the presence of metal compounds as catalysts and compounds capable of enediol formation as co-catalysts (see, e.g., U.S. Pat. No. 4,341,909 (Schneider et al.), U.S. Pat. No. 4,247,653 (Wagner), U.S. Pat. No. 4,221,876 (Wagner), U.S. Pat. No. 4,326,086 (Mohring et al.), and U.S. Pat. No. 4,205,138 (Muller et al.), as well as CA 1,088,523 (Bayer AG)). Solutions of polyisocyanate polyaddition products, particularly solutions of polyurethane ureas containing ionic groups and/or solutions of polyhydrazodicarbonamides, in low molecular weight polyhydric alcohols can also be used (see DE 2,638,759).

Many other compounds containing isocyanate-reactive hydrogen atoms are useful in the preferred foamable compositions of the invention, as will be apparent to those skilled in the art of polyurethane science and technology.

Phenolic polymer precursors suitable for use in the provided foamable compositions include the reaction product of a phenol and an aldehyde in the presence of a catalyst. Illustrative uses of phenolic foams of this invention include use for roofing insulation, as sheathing products for external wall insulation for building applications, and for shaped parts such as pipe and block insulation for industrial applications, as described in “Thermal Insulation,” Encyclopedia of Chemical Technology, vol. 14, pages 648-662 (4th ed., John Wiley & Sons, 1995).

Typical polymeric foams can be prepared using the provided foamable compositions by vaporizing (e.g., by utilizing the heat of precursor reaction) at least one blowing agent in the presence of a nucleating agent as described above, at least one organic polyisocyanate and at least one compound containing at least two reactive hydrogen atoms. In making a polyisocyanate-based foam, the polyisocyanate, reactive hydrogen-containing compound, and blowing agent composition can generally be combined, thoroughly mixed (using, e.g., any of the various known types of mixing head and spray apparatus), and permitted to expand and cure into a cellular polymer. It is often convenient, but not necessary, to preblend certain of the components of the foamable composition prior to reaction of the polyisocyanate and the reactive hydrogen-containing compound. For example, it is often useful to first blend the reactive hydrogen-containing compound, blowing agent composition, and any other components (e.g., surfactant) except the polyisocyanate, and to then combine the resulting mixture with the polyisocyanate. Alternatively, all components of the foamable composition can be introduced separately. It is also possible to pre-react all or a portion of the reactive hydrogen-containing compound with the polyisocyanate to form a prepolymer.

The provided foamable compositions include a nucleating agent that includes a fluorinated oxirane. The Handbook of Polymeric Foams and Foam Technology, Daniel Klempner and Kurt C. Frisch, ed., (Oxford University Press, 1991), discloses that formation of uniform, fine cellular structure can be obtained by using “nucleazites”, also referred to as nucleating agents. The Handbook classifies “nucleazites” into three categories based on their mode of action as follows: (1) gaseous and liquid compounds that produce a supersaturated gas in the foamable composition and which form fine bubbles prior to action by a blowing agent (e.g., carbon dioxide, nitrogen, sodium bicarbonate, citric acid, and sodium citrate), (2) finely dispersed organic, inorganic, or metal powders that form so called “hot spots”, and (3) finely dispersed compounds that provide nucleation centers at which the blowing agent converts to gaseous phase (e.g., talc, silicon dioxide, titanium dioxide, diatomaceous earth, kaolin, etc.).

Fluorinated oxiranes useful in the provided compositions and processes can be oxiranes that have a carbon backbone which is fully fluorinated (perfluorinated), i.e., substantially all of the hydrogen atoms in the carbon backbone have been replaced with fluorine or oxiranes that can have a carbon backbone which is fully or partially fluorinated having, in some embodiments, up to a maximum of three hydrogen atoms.

The provided fluorinated oxiranes can be derived from fluorinated olefins that have been oxidized with epoxidizing agents. In the provided fluorinated oxirane compositions the carbon backbone includes the whole carbon framework including the longest hydrocarbon chain (main chain) and any carbon chains branching off of the main chain. In addition, there can be one or more catenated heteroatoms interrupting the carbon backbone such as oxygen, nitrogen, or sulfur atoms, for example ether or hexavalent sulfur functionalities. The catenated heteroatoms are not directly bonded to the oxirane ring. In these cases the carbon backbone includes the heteroatoms and the carbon framework attached to the heteroatom.

Typically, the majority of halogen atoms attached to the carbon backbone are fluorine; most typically, substantially all of the halogen atoms are fluorine so that the oxirane is a perfluorinated oxirane. The provided fluorinated oxiranes can have a total of 4 to 12 carbon atoms. Representative examples of fluorinated oxirane compounds suitable for use in the provided processes and compositions include 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2,3-bis-trifluoromethyl-oxirane, 2-pentafluoroethyl-3-trifluoromethyl-oxirane, 2-(1,2,2,2-tetrafluoro-1-trifluoromethyl-ethyl)-3-trifluoromethyl-oxirane, 2-nonafluorobutyl-3-pentafluoroethyl-oxirane, 2,2-bis-trifluoromethyl-oxirane, 2-heptafluoroisopropyloxirane, 2-heptafluoropropyloxirane, 2-nonafluorobutyloxirane, 2-tridecafluorohexyloxirane, and oxiranes of HFP trimer including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

The provided fluorinated oxirane compounds can be prepared by epoxidation of the corresponding fluorinated olefin using an oxidizing agent such as sodium hypochlorite, hydrogen peroxide or other well known epoxidizing agent such as peroxycarboxylic acids such as meta-chloroperoxybenzoic acid or peroxyacetic acid. The fluorinated olefinic precursors can be directly available as, for example, in the cases of 1,1,1,2,3,4,4,4-octafluoro-but-2-ene (for making 2,3-difluoro-2,3-bis-trifluoromethyl oxirane), 1,1,1,2,3,4,4,5,5,5-decafluoro-pent-2-ene (for making 2,3-difluoro-2-trifluoromethyl-3-pentafluoroethyl oxirane) or 1,2,3,3,4,4,5,5,6,6 decafluoro-cyclohexene (for making 1,2,2,3,3,4,4,5,5,6-decafluoro-7-oxa-bicyclo[4.1.0]heptane). Other useful fluorinated olefinic precursors can include oligomers of hexafluoropropene (HFP) and tetrafluoroethylene (TFE) such as dimers and trimers. The HFP oligomers can be prepared by contacting 1,1,2,3,3,3-hexafluoro-1-propene (hexafluoropropene) with a catalyst or mixture of catalysts selected from the group consisting of cyanide, cyanate, and thiocyanate salts of alkali metals, quaternary ammonium, and quaternary phosphonium in the presence of polar, aprotic solvents such as, for example, acetonitrile. The preparation of these HFP oligomers is disclosed, for example, in U.S. Pat. No. 5,254,774 (Prokop). Useful oligomers include HFP trimers or HFP dimers. HFP dimers include a mixture of cis- and trans-isomers of perfluoro-4-methyl-2-pentene as indicated in Table 1 in the Example section below. HFP trimers include a mixture of isomers of C₉F₁₈. This mixture has six main components that are also listed in Table 1 in the Example section.

The provided fluorinated oxirane compounds can have a boiling point in a range of from about 0° C. to about 170° C. In some embodiments, the fluorinated oxirane compounds can have a boiling point in the range of from about 0° C. to about 130° C. In other embodiments, the fluorinated oxiranes compounds can have a boiling range of from about 20° C. to about 55° C. Some exemplary materials and their boiling point ranges are disclosed in the Examples section below.

Fluorooxiranes that are useful in the present invention include those oxiranes having mostly fluorine attached to the carbon backbone. More specifically, the instant fluorinated oxiranes are of formula:

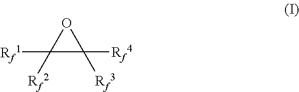

wherein each of R_{f}¹, R_{f}², R_{f}³ and R_{f}⁴ are selected from a hydrogen atom, a fluorine atom or a fluoroalkyl group, preferably a fluorine atom or a perfluoroalkyl group, and the sum of the carbon atoms of said perfluorooxiranes is 2 to 10. In some embodiments any two of said R_{f} groups may be joined together to form a fluorocycloalkyl ring, preferably a perfluorocycloalkyl ring. C₄-C₁₂ fluoroxiranes have 3 or fewer hydrogen atoms, typically substantially no carbon-hydrogen bonds.

Fluorooxiranes that are useful in the present invention can also include those oxiranes having one to three hydrogen atoms attached to the carbon backbone. More specifically, useful fluorinated oxiranes are of the formula (I) wherein each of R_{f}¹, R_{f}², R_{f}³ and R_{f}⁴ are selected from a fluorine atom, a hydrogen atom or a fluoroalkyl group; wherein the sum of the hydrogen atoms is 1 to 3 and: wherein the sum of the carbon atoms of the fluorinated oxirane is 4 to 12.

In some embodiments any two of said R_{f} groups may be joined together to form a fluorocycloalkyl ring of the formula:

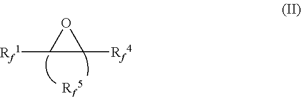

wherein each of R_{f}¹, and R_{f}⁴ are selected from a hydrogen atom, a fluorine atom or a fluoroalkyl group, R_{f}⁵ is a fluoroalkylene group of 2 to 5 carbon atoms, and the sum of the carbon atoms is 4 to 12. Preferably each of R_{f}¹ and R_{f}⁴ are selected from a fluorine atom or a perfluoroalkyl group.

With respect to Formulas (I) and (II), R_{f}¹ to R_{f}⁴ are each F, or monovalent fluoroalkyl groups having 1 to 5 fluorinated or perfluorinated carbon atoms, optionally, containing one or more catenary (in-chain) heteroatoms, such as divalent oxygen, hexavalent sulfur, or trivalent nitrogen bonded only to carbon atoms, such heteroatoms being a chemically stable link between fluorocarbon portions of the fluoroaliphatic group and which do not interfere with the inert character of the fluoroaliphatic group. In typical embodiments, R_{f}¹ to R_{f}⁴ are fluorine atoms or perfluoroalkyl groups. The skeletal chain of R_{f}¹ to R_{f}⁴ can be straight chain, branched chain, and if sufficiently large, cyclic, such as fluorocycloaliphatic groups, e.g. R_{f}⁵ as shown in Formula (II). In some embodiments at least one of R_{f}¹ to R_{f}⁴ is a branched perfluoraliphatic group.

In some embodiments, a fluorine atom of one or more of the R_{f}¹ to R_{f}⁵ groups may be replaced by one, two, or even three hydrogen atoms; e.g., a perfluoroalkyl or perfluoroalkylene group may be a mono-, di-, or tri-hydridoperfluoroalkyl or a mono-, di-, or tri-hydridoperfluoroalkylene. In such substitutions, it is typical that only one or two fluorine atoms be replaced to provide mono- or dihydridoperfluorooxiranes.

The HFP oligomers can be prepared by contacting 1,1,2,3,3,3-hexafluoro-1-propene (hexafluoropropene) with a catalyst or mixture of catalysts selected from the group consisting of alkali metal, quaternary ammonium, and quaternary phosphonium salts of cyanide, cyanate, and thiocyanate of in the presence of polar, aprotic solvents such as, for example, acetonitrile. The preparation of these HFP oligomers is disclosed, for example, in U.S. Pat. No. 5,254,774 (Prokop). Useful oligomers include HFP trimers or HFP dimers. HFP dimers include a mixture of isomers of C₆F₁₂. HFP trimers include a mixture of isomers of C₉F₁₈.

Also provided are compositions that include one or more nucleating agents as described above and one or more blowing agents as discussed above. The molar ratio of nucleating agent to blowing agent is typically about 1:9. Higher proportions of nucleating agent may be used in some embodiments (e.g., a molar ratio of about 1:7), but will typically be more expensive. In some embodiments, lesser proportions of nucleating agent (e.g., 1:25 or even 1:50) may be used.

Other conventional components of foam formulations can, optionally, be present in the foamable compositions of the invention. For example, cross-linking or chain-extending agents, foam-stabilizing agents or surfactants, catalysts and fire-retardants can be utilized. Other possible components include fillers (e.g., carbon black), colorants, fungicides, bactericides, antioxidants, reinforcing agents, antistatic agents, and other additives or processing aids known to those skilled in the art.

Typically, the foamable compositions of the invention can include at least one surfactant. Suitable surfactants include fluorochemical surfactants, organosilicone surfactants, polyethylene glycol ethers of long chain alcohols, tertiary amine or alkanolamine salts of long chain alkyl acid sulfate esters, alkyl sulfonate esters, alkyl arylsulfonic acids, fatty acid alkoxylates, and mixtures thereof. Surfactant is generally employed in amounts sufficient to stabilize the foaming reaction mixture against collapse and the formation of large, uneven cells. Typically, from about 0.1 to about 5 percent by weight of surfactant is sufficient for this purpose. Organosilicone surfactants and fluorochemical surfactants are preferred. In addition, the surfactant can help to disperse or emulsify the nucleating agent into the foamable composition.

The foamable composition typically also contains a catalyst. Catalysts suitable for use in the provided foamable compositions include compounds which greatly accelerate the reaction of the reactive hydrogen-containing compounds (or the cross-linking or chain-extending agents) with the polyisocyanates. When used, catalysts are generally present in amounts sufficient to be catalytically effective. Suitable catalysts include organic metal compounds (preferably, organic tin compounds), which can be used alone or, preferably, in combination with amines. Representative examples of these and other types of suitable catalysts are described in U.S. Pat. No. 4,972,002 (Volkert).

Foams prepared from the provided foamable compositions can vary in texture from very soft types useful in upholstery applications to rigid foams useful as structural or insulating materials. The foams can be used, for example, in the automobile, shipbuilding, aircraft, furniture, and athletic equipment industries, and are especially useful as insulation materials in the construction and refrigeration industries.

Objects and advantages of this invention are further illustrated by the following examples, but the particular materials and amounts thereof recited in these examples, as well as other conditions and details, should not be construed to unduly limit this invention.

TABLE 1
Materials

| Chemical | Description | Source |
|---|---|---|
| DESMODUR 44V-20 | Polymeric diisocyanate having an isocyanate | Bayer AG |
| | content of 31.5% by weight and a viscosity of | |
| | 200 ± 40 cps at 25° C. | |
| BAYTHERM VP-PU | Polyether polyol having a hydroxyl equivalent | Bayer AG |
| 1751 A/2 | weight of 425 mg KOH/g, a water content of | |
| | 4.6 parts by weight and a catalyst content of | |
| | 3.7 parts by weight N,N-dimethylcyclohexylamine. | |
| BAYTHERM VP-PU | Polyether polyol having a hydroxyl equivalent | Bayer AG |
| 1832 A/2 | weight of 520 mg KOH/g, a water content of 1.9 | |
| | parts and a catalyst content of 3.7 parts | |
| | N,N-dimethylcyclohexylamine | |
| Polyol KP-990 | Polyether polyol | Korea Polyol, Seoul Korea |
| Silicone Surfactant | | T. H. Goldschmidt Berlin, |
| B-8423 | | Germany |
| FC-4430 | NOVEC Fluorosurfactant FC-4430 | 3M Company, St. Paul, MN |
| POLYCAT 5 | Pentamethyldiethylenetriamine catalyst | Air Products, Allentown, PA |
| POLYCAT 41 | N, N′, N″-tris(dimethylaminopropyl)-sym- | Air Products, Allentown, PA |
| | hexahydrotriazine | |
| TISAB II Buffer | Total ionic strength adjustment buffer | Thermo Scientific, Boston, MA |
| 1,1,1,2,3,4,5,5,5- nonafluoro-4- trifluoromethyl-pent-2-ene | HFP Dimers - 2 isomers; 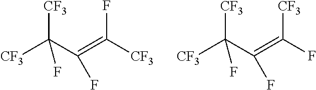 [SMILES: F/C(=C(/F)C(F)(C(F)(F)F)C(F)(F)F)C(F)(F)F ; F/C(=C(\F)C(F)(C(F)(F)F)C(F)(F)F)C(F)(F)F] | 3M Foam Additive FA-188, 3M, St. Paul, MN. |
| HFP Trimers | HFP Trimers - 6 Isomers; 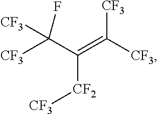 [SMILES: FC(F)(F)C(=C(C(F)(F)C(F)(F)F)C(F)(C(F)(F)F)C(F)(F)F)C(F)(F)F] (45%) | U.S. Pat. No. 5,254,774 |
| | 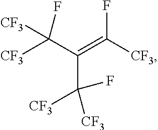 [SMILES: FC(=C(C(F)(C(F)(F)F)C(F)(F)F)C(F)(C(F)(F)F)C(F)(F)F)C(F)(F)F] (25%) | |
| | 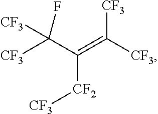 [SMILES: FC(F)(F)C(=C(C(F)(F)C(F)(F)F)C(F)(C(F)(F)F)C(F)(F)F)C(F)(F)F] (14.5%) | |
| | 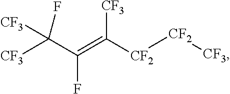 [SMILES: F/C(=C(/C(F)(F)F)C(F)(F)C(F)(F)C(F)(F)F)C(F)(C(F)(F)F)C(F)(F)F] (12%), | |
| | 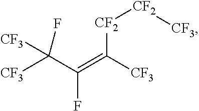 (3%) | |
| | 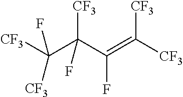 [SMILES: FC(=C(C(F)(F)F)C(F)(F)F)C(F)(C(F)(F)F)C(F)(C(F)(F)F)C(F)(F)F] (0.5%) | |
| HFPDO | Oxiranes of HFP Dimers | Preparatory Example 1 |
| HFPTO | Oxiranes of HFP Trimers | Preparatory Example 2 |
| Hydrogen Peroxide (50%) | H₂O₂ | GFS Chemicals, Inc., |
| | | Powell, OH |
| Potassium Hydroxide | KOH | Sigma Aldrich, Milwaukee, WI |
| Acetonitrile | CH₃CN | Honeywell Burdick & |
| | | Jackson, Morristown, NJ |
| 1N Sulfuric Acid | H₂SO₄ | Sigma Aldrich, Milwaukee, WI |
| Isopropanol | (CH₃)₂CHOH | Sigma Aldrich, Milwaukee, WI |
| 1,1,1,2,2,3,4,5,5,5- | CF₃CF₂CF(OCH₃)CF(CF₃)CF₃ | Novec 7300 Engineered |
| decafluoro-3-methoxy-4- | | Fluid, 3M, St. Paul, MN |
| (trifluoromethyl)-pentane | | |

### Preparatory Example 1

### Synthesis of 2,3-difluoro-2-(1,2,2,2-tetrafluoro-1-trifluoromethyl-ethyl)-3-trifluoromethyl-oxirane. (C₆F₁₂O, HFPDO)

In a 1.5 liter glass reactor fitted with a mixer and a cooling jacket, 400 grams of acetonitrile, 200 grams of 1,1,1,2,3,4,5,5,5-nonafluoro-4-trifluoromethyl-pent-2-ene and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 155 grams of the product crude was collected from the bottom product phase. The product crude was then washed with 200 grams of water to remove solvent acetonitrile and then purified in a 40-tray Oldershaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 52° C. and 53° C.

The 90 grams of the final product collected from the method above was analyzed by 376.3 MHz ¹⁹F-NMR spectra and identified as a mixture of 2,3-difluoro-2-(1,2,2,2-tetrafluoro-1-trifluoro-methyl-ethyl)-3-trifluoromethyl-oxirane, 95.8% and 2.2% of 2-fluoro-2-pentafluoroethyl-3,3-bis-trifluoromethyl-oxirane.

### Preparatory Example 2

### C₉ Oxirane Synthesis and purification of HFP Trimer-oxirane (C₉F₁₈O, HFPTO)

In a 1.5 liter glass reactor fitted with a mixer and a cooling jacket, 400 grams of acetonitrile, 200 grams of HFP Trimer (C₉F₁₈), and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature between 0° C. and 20° C. After all the hydrogen peroxide was added within about 2 hours, the mixer was turned off to allow the product crude to phase split from solvent and aqueous phases. 180 grams of the product crude was collected from the bottom product phase. The product crude was then washed with 200 grams of water to remove solvent acetonitrile and then purified in a 40-tray Oldershaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 120° C. and 122° C.

The 150 grams of the final product collected from the method above was analyzed by 376.3 MHz ¹⁹F-NMR spectra and identified as oxiranes of HFP trimer (C₉F₁₈O) with 5 isomeric forms. The sum of all 5 isomers had a purity of 99.4%.

### Examples 1-6 and Comparative Examples 1-3

The compositions used in Examples 1-6 and Comparative Examples 1-3 are shown in Tables 2 and 3. The fluorinated nucleating agent (3.5 grams) was emulsified in BAYTHERM VP-PU 1751 A/2 (118 g) and silicone surfactant B-8423 (3.5 g) using a high shear mixer at 6000 rpm. DESMODUR 44V-20 (225 g) was then added to this emulsion while mixing at 6000 rpm for 15 seconds. The resulting mixture was poured into a 350 cm×350 cm×60 cm aluminum mold that was preheated to 50° C. The reaction was allowed to continue in the mold for about 30 minutes. The polyurethane sample was demolded and cut. The thermal conductivity (lambda) values of the foams were measured on a 200 cm×200 cm×25 cm test sample, perpendicular to the foam rise direction. The thermal conductivity was measured at a temperature of 23° C. initially and after heat aging at 50° C. for 2 weeks using a Hesto Lambda Control A-50 thermal conductivity analyzer with a reproducibility of ±0.1 milliWatt/meter*Kelvin. The range of cell size diameters described in the examples and the comparative examples were designated as follows:

| | |
|---|---|
| Very Fine | 70-100 micrometers |
| Fine | 100-150 micrometers |
| Medium | 150-200 micrometers |
| Large | 200-300 micrometers |
| Very Large | >300 micrometers |

TABLE 2
Water-blown Foams

| | Ex 1 | Ex 2 | Comp. Ex. 1 |
|---|---|---|---|
| Polyol 1751 A/2 | 118 g | 118 g | 118 g |
| Silicone Surfacant B-8423 | 3.5 g | 3.5 g | 3.5 g |
| HFPDO | 3.5 g | — | — |
| HFPTO | — | 3.5 g | — |
| Isocyanate 44 V-20 | 225 g | 225 g | 225 g |
| Foam density (kg/m³) | 38.8 | 39.3 | 39.1 |
| Thermal Conductivity | | | |
| Initial (mW/m * K) | 23.8 | 22.4 | 26.2 |
| Aged (mW/m * K) | 31.4 | 30.2 | 36.5 |
| Average Cell Size | Large | Medium | Very large |

TABLE 3
Hydrocarbon-blown foams

| | | | | | Comp | Comp |
|---|---|---|---|---|---|---|
| | Ex 3 | Ex 4 | Ex 5 | Ex 6 | Ex 2 | Ex 3 |
| Polyol 1832 A/2 | 122 g | 122 g | 122 g | 122 g | 122 g | 122 g |
| Isocyanate 44 V-20 | 199 g | 199 g | 199 g | 199 g | 199 g | 199 g |
| Cyclopentane | 15 g | 15 g | 15 g | — | 15 g | 15 g |
| Silicone Surfactant | 3.5 g | 3.5 g | — | 3.5 g | 3.5 g | 3.5 g |
| B-8423 | | | | | | |
| Pentane | — | — | — | 15 g | — | — |
| HFP-dimer | — | — | — | — | 3.5 g | — |
| HFPDO | 3.5 g | — | — | 3.5 g | — | — |
| HFPTO | — | 3.5 g | 3.5 g | — | — | — |
| FC-4430 | — | — | 3.5 g | — | — | — |
| Foam Density (kg/m³) | 25.5 | 26.1 | 25.9 | 24.9 | 25.4 | 25.8 |
| Thermal Conductivity | 20.5 | 20.1 | 20.6 | 22.5 | 20.3 | 22.3 |
| Initial (mW/m * K) | | | | | | |
| Aged (mW/m * K) | 22 | 21.7 | 22.2 | 25.9 | 22 | 25.6 |
| Average Cell Size | Fine | Fine | Fine | Fine | Fine | Medium |

The preceding examples demonstrate that the oxiranes of HFP dimer (HFPDO) and HFP trimer (HFPTO) reduce the cell size and thermal conductivity of a rigid, polyurethane foam insulation blown with either water or a hydrocarbon blowing agent.

### Examples 7-8 and Comparative Examples 4-5

In the following examples, the fluorinated nucleating agents were evaluated for reactivity with amine catalysts by forming an emulsion of nucleating agent within a polyol formulation and measuring the concentration of fluoride ion generated over time. A master batch of polyol was prepared containing water, surfactant and catalyst. From this master batch, samples were prepared by emulsifying a mixture of blowing agent and fluorinated nucleating agent into the polyol at their respective concentrations as shown in Table 4. The samples were then examined for generation of fluoride ion, with the initial measurement made immediately after sample preparation and additional measurements made over time as the samples age.

TABLE 4
Polyol Emulsion Formulation

| | |
|---|---|
| Polyol (KP-990) | 100 g |
| Water | 2.0 g |
| Silicone Surfactant B- | 2.0 g |
| 8423 | |
| Catalyst (PC-5) | 0.3 g |
| Catalyst (PC-41) | 0.8 g |
| Cyclopentane | 16.5 g |
| Nucleating Agent | 2.0 g |

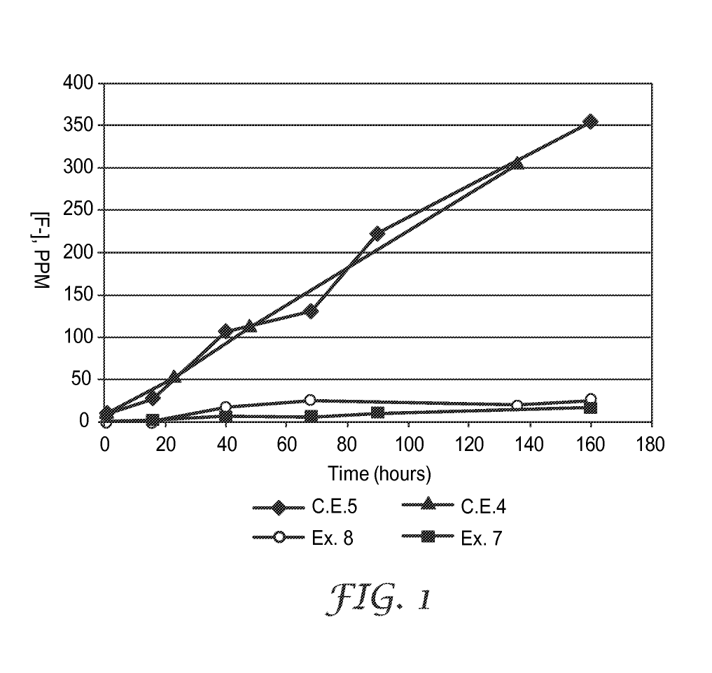

The fluoride ion concentration was determined by diluting 1 g of polyol emulsion with 1 g of isopropanol and adding 0.5 ml of 1N H₂SO₄. This was mixed and then further diluted with 1 g of water. 1 ml of this aqueous mixture was combined with 1 ml of TISAB II buffer (Total Ionic Strength Adjustment Buffer) for fluoride measurement using a fluoride specific electrode. Relative mV readings were recorded and converted to F concentrations (in ppm) from a calibration equation for that electrode. Increasing concentrations of fluoride ion in the polyol emulsions indicate that the fluorinated nucleating agent is unstable in this formulation and is undergoing a reaction in the presence of the catalysts. The results are displayed in Table 5 and in FIG. 1.

TABLE 5
Nucleating Agent Stability

| | Ex. 7 | Ex. 8 | Comp. Ex. 4 | Comp. Ex. 5 |
|---|---|---|---|---|
| time | HFPDO | HFPTO | HFE7300 | HFPD |
| (hours) | [F−], ppm | [F−], ppm | [F−], ppm | [F−], ppm |
| 1 | 0.3 | | 6.9 | 7.7 |
| 16 | 2.0 | 16.5 | | 26 |
| 23 | | | 52.4 | |
| 40 | 4.8 | 25.3 | | 105 |
| 48 | | | 111 | |
| 68 | 4.6 | 19 | | 129 |
| 90 | 9.3 | 25.4 | | 221 |
| 136 | | | 305 | |
| 160 | 16.2 | 30.4 | | 354 |

The preceding examples demonstrate that the oxiranes of HFP dimer (HFPDO) and HFP trimer (HFPTO) exhibit reduced reactivity with the amine catalysts and are more compatible with the foam formulation.

Following are exemplary embodiments of polymeric foams including fluorinated oxiranes, methods of preparation, and use of same according to aspects of the present invention.

Embodiment 1 is a foamable composition comprising at least one blowing agent, at least one foamable polymer or a precursor composition thereof, and a nucleating agent wherein said nucleating agent comprises a fluorinated oxirane.

Embodiment 2 is a foamable composition according to embodiment 1, wherein the fluorinated oxirane includes up to a maximum of three hydrogen atoms.

Embodiment 3 is a foamable composition according to embodiment 2, wherein the fluorinated oxirane contains substantially no hydrogen atoms bonded to carbon atoms.

Embodiment 4 is a foamable composition according to embodiment 1, wherein the fluorinated oxirane has a total of from about 4 to about 12 carbon atoms.

Embodiment 5 is a foamable composition according to embodiment 1, wherein the fluorinated oxirane has the formula:

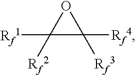

wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

Embodiment 6 is a foamable composition according to embodiment 1, wherein the nucleating agent and the blowing agent are in a molar ratio of less than 1:9.

Embodiment 7 is a foamable composition according to embodiment 1, wherein the blowing agent is selected from the group consisting of aliphatic hydrocarbons having from about 5 to about 7 carbon atoms, cycloaliphatic hydrocarbons having from about 5 to about 7 carbon atoms, hydrocarbon esters and water.

Embodiment 8 is a process for preparing polymeric foam comprising the step of vaporizing at least one liquid or gaseous blowing agent or generating at least one gaseous blowing agent in the presence of at least one foamable polymer or a precursor composition thereof and a nucleating agent wherein said nucleating agent comprises a fluorinated oxirane.

Embodiment 9 is a process for preparing polymeric foam according to embodiment 8, wherein the fluorinated oxirane includes up to a maximum of three hydrogen atoms.

Embodiment 10 is a process for preparing polymeric foam according to embodiment 9, wherein the fluorinated oxirane contains substantially no hydrogen atoms bonded to carbon atoms.

Embodiment 11 is a process for preparing polymeric foam according to embodiment 8, wherein the fluorinated oxirane has a total of from about 4 to about 12 carbon atoms.

Embodiment 12 is a process for preparing polymeric foam according to embodiment 8, wherein the fluorinated oxirane has the formula:

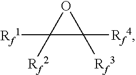

wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

Embodiment 13 is a process for preparing polymeric foam according to embodiment 8, wherein the nucleating agent and the blowing agent are in a molar ratio of less than 1:9.

Embodiment 14 is a composition comprising a blowing agent and a nucleating agent wherein the nucleating agent comprises a fluorinated oxirane.

Embodiment 15 is a composition according to embodiment 14, wherein the fluorinated oxirane includes up to a maximum of three hydrogen atoms.

Embodiment 16 is a composition according to embodiment 15, wherein the fluorinated oxirane contains substantially no hydrogen atoms bonded to carbon atoms.

Embodiment 17 is a composition according to embodiment 14, wherein the fluorinated oxirane has a total of from about 4 to about 12 carbon atoms.

Embodiment 18 is a composition according to embodiment 14, wherein the fluorinated oxirane has the formula:

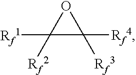

wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

Embodiment 19 is a composition according to embodiment 14, wherein the nucleating agent and the blowing agent are in a molar ratio of less than 1:9.

Embodiment 20 is a foam made with the foamable composition according to embodiment 1.

Embodiment 21 is a foam made according to the process according to embodiment 8.

Embodiment 22 is a foam made with the composition according to embodiment 14.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A foamable composition comprising at least one blowing agent, at least one foamable polymer or a precursor composition thereof, and a nucleating agent wherein said nucleating agent comprises a fluorinated oxirane, wherein the fluorinated oxirane has a total of from about 4 to about 12 carbon atoms.

2. A foamable composition according to claim 1, wherein the fluorinated oxirane includes up to a maximum of three hydrogen atoms.

3. A foamable composition according to claim 1, wherein the fluorinated oxirane contains substantially no hydrogen atoms bonded to carbon atoms.

4. (canceled)

5. A foamable composition according to claim 1, wherein the fluorinated oxirane has the formula: 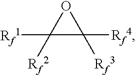
wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

6. A foamable composition according to claim 1, wherein the nucleating agent and the blowing agent are in a molar ratio of less than 1:9.

7. A foamable composition according to claim 1, wherein the blowing agent is selected from the group consisting of aliphatic hydrocarbons having from about 5 to about 7 carbon atoms, cycloaliphatic hydrocarbons having from about 5 to about 7 carbon atoms, hydrocarbon esters and water.

8. A process for preparing polymeric foam comprising the step of vaporizing at least one liquid or gaseous blowing agent or generating at least one gaseous blowing agent in the presence of at least one foamable polymer or a precursor composition thereof and a nucleating agent wherein said nucleating agent comprises a fluorinated oxirane, wherein the fluorinated oxirane has a total of from about 4 to about 12 carbon atoms.

9. A process for preparing polymeric foam according to claim 8, wherein the fluorinated oxirane includes up to a maximum of three hydrogen atoms.

10. A process for preparing polymeric foam according to claim 9, wherein the fluorinated oxirane contains substantially no hydrogen atoms bonded to carbon atoms.

11. (canceled)

12. A process for preparing polymeric foam according to claim 8, wherein the fluorinated oxirane has the formula: 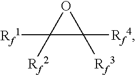
wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

13. A process for preparing polymeric foam according to claim 8, wherein the nucleating agent and the blowing agent are in a molar ratio of less than 1:9.

14. A composition comprising a blowing agent and a nucleating agent wherein the nucleating agent comprises a fluorinated oxirane, wherein the fluorinated oxirane has a total of from about 4 to about 12 carbon atoms.

15. A composition according to claim 14, wherein the fluorinated oxirane includes up to a maximum of three hydrogen atoms.

16. A composition according to claim 15, wherein the fluorinated oxirane contains substantially no hydrogen atoms bonded to carbon atoms.

17. (canceled)

18. A composition according to claim 14, wherein the fluorinated oxirane has the formula: 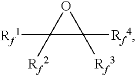
wherein each of R_{f}¹, R_{f}², R_{f}³ and R_{f}⁴ are selected from a hydrogen atom, a fluorine atom or a fluoroalkyl group, and the sum of the carbon atoms of said R_{f} groups is 2 to 10, and any two of said R_{f} groups may be joined together to form a perfluorcycloalkyl ring.

19. A composition according to claim 14, wherein the nucleating agent and the blowing agent are in a molar ratio of less than 1:9.

20. A foam made with the foamable composition according to claim 1.

21. A foam made according to the process according to claim 8.

22. A foam made with the composition according to claim 14.
